(19) United States
(12) Patent Application Publication
(10) Pub. No.: US 2020/0277208 A1
(43) Pub. Date: Sep. 3, 2020

(54) SYSTEMS AND METHODS FOR TREATING WATER

(71) Applicant: Frimont SA, Lujan de Cuyo (AR)

(72) Inventor: Sergio Omar Escalante, Lujan de Cuyo (AR)

(21) Appl. No.: 16/806,444

(22) Filed: Mar. 2, 2020

Related U.S. Application Data
(60) Provisional application No. 62/812,522, filed on Mar. 1, 2019.

(51) Int. Cl. C02F 1/46; C02F 1/461

(52) U.S. Cl. CPC C02F 1/4606; C02F 2103/023; C02F 1/46104

(57) ABSTRACT

A method of treating water includes providing an ion dispenser having a first electrode and a second electrode and flowing a volume of water through the first electrode and the second electrode such that each electrode is positioned in contact with the volume of water. The method further includes selecting an electric current to apply to the volume of water and determining an electric potential energy differential to apply to the volume of water, wherein the electric potential energy differential is operable to generate the electric current. In addition, the method includes applying the electric current to the first volume of water.

### PRIORITY

This application claims priority to U.S. Provisional Patent Application Ser. No. 62/812,522, filed Mar. 1, 2019, entitled “Systems and Methods for Treating Water,” the disclosure of which is incorporated by reference herein.

### TECHNICAL FIELD

Embodiments of this disclosure relate generally to systems and methods of treating water in water systems and, more particularly, to treating fouling in water systems using ionization.

### BACKGROUND

Various mechanical systems involving the recirculation of water through a series of water pipes, pieces of equipment, and containers such as, for example, heat exchangers, condensing water loops, and evaporative towers (“water systems” or “recirculating water systems”), often require water treatments to reduce and/or prevent fouling. “Fouling” refers to the accumulation of unwanted deposits on heat transfer surfaces, such as concentrated solids from the combined effects of evaporation, air scrubbing, leaching, and corrosion whereby incrustations, algae, scale, microorganisms, or biofilm may develop within the recirculating water system. The damp, warm, and dark conditions in recirculating water systems often leads to the rapid growth of algae, bacteria, fungus, and other organic compounds generally referred to as “biofilm.” The circulating water is rich in dissolved oxygen and other nutrients to enhance the growth and spread of biofilm. The mass, when it settles in the water system, can become an insoluble and restricting sludge. Components of water systems can also deteriorate (e.g., corrode) over time and the deteriorations may result in rust forming on surfaces or incrustations of calcium carbonates, magnesium, and/or silicates.

As mentioned above, an evaporative tower is one example of a recirculating water system. An evaporative tower is a direct contact heat exchanger that drives ambient air through falling water, causing part of the hot water to evaporate and the rest to cool. Then, the water is circulated through any equipment that needs cooling (e.g., a surface heat exchanger or, more specifically, a condenser or cooler). The evaporative towers, being open, collect pollutants from the ambient air. Evaporated water is pure water while the replacement water contains salts. This process generates a concentration of salts within water that remains within the recirculating system of the evaporative tower. Typically, chlorine and/or other chemicals are added to the water in the evaporative tower to control biofilm and inhibit the accumulation of scale. The control of biofilm and scale is essential to maintain the heat transfer efficiency of the evaporative tower and the associated heat exchangers. Another way to maintain the water conditions is by periodically renewing the water through a process called “purge and replenishment.” Purge water and water that is lost through evaporation are replaced by new “replenishment” water (which also could contain minerals and other impurities).

In some applications, evaporative towers cool water used in facilities in various capacities, such as in air conditioning systems, manufacturing processes, and other operations that require a cooling circuit. If water is not treated, the equipment or facilities can accumulate minerals (such as scale) and biological growth (biofilm) due to the bacteria, algae, fungi, and viruses that may be present in the water.

Any of the circumstances as described above can reduce the performance of the water system by contributing to higher energy consumption or progressively damaging the water system equipment and decreasing its useful lifetime. System efficiency can also be reduced by maintenance shutdowns for removal of deposits and the repair or replacement of piping, valves, and equipment abraded by the suspended particles in the water or damaged by corrosion.

As with evaporative towers, many other water systems commonly require chemical products, anti-flocculants, biocides, and antioxidants to reduce or prevent fouling. The formation of scale can be controlled by such dosing chemicals or can be removed by strong physicochemical actions, such as acid combined with strong mechanical cleaning. Magnetic and electromagnetic systems can also be used to control the formation of scale. Ion dispensers or ionizers, mainly with silver and copper ions, can also be used to prevent fouling, because they actively impede growth of a wide range of bacteria, fungi, algae, and viruses, including pathogenic organisms such as Legionella, which are found as contaminants in surface water systems. The copper and silver ions can eliminate these microorganisms by attacking the microorganisms at the cellular level. As such, copper and silver ions can be effective in reducing the nutrients available for supporting microbiological life and in penetrating the resistant biofilms that house the anaerobic bacteria responsible for microbiological corrosion.

There are various research reports and articles that have been previously written which discuss preventing scaling. For example, “Mitigation of scaling in heat exchangers by physical water treatment using zinc and tourmaline,” by Tijing, Yu, Kim, Amarjargal, Lee, Lee, Kim, and Pant (Applied Thermal Engineering, 2011). Also, for example, “Inhibition of CaCO3 scaling by zinc(II) and copper(II): A comparative review,” by Kai (ResearchGate, 2016). The entire disclosures of these references, except for any definitions, disclaimers, disavowals, and inconsistencies, are incorporated herein by reference.

However, it was realized by the inventor of the current disclosure that improvements in water treatment for recirculating water systems are needed. More specifically, it was realized that improvements in using ionization for treating water are needed. One or more embodiments disclosed herein are directed toward such improvements.

### SUMMARY

Some embodiments disclosed herein provide improved systems and methods for treating water in water systems. Unlike the traditional chemical products used to combat these microbiological problems (e.g., oxidants) which are often highly corrosive, embodiments of the systems and methods described herein may achieve control over microorganisms without incorporating harsh chemicals. Oftentimes, chemical treatments must be accompanied by other maintenance practices such as periodic purges, sanitary discharge control, and physical-chemical procedures to remove scale, which can lead to erosion/corrosion of pipe surfaces, equipment and accessories and a reduction in their useful life and increase in maintenance costs. Embodiments disclosed herein describe ionization techniques. Ionization is the electrochemical generation of metal ions in water as an advantageous water treatment method for at least the reasons illustrated and described herein.

Embodiments disclosed herein describe systems and methods for treatment of water circulating through or evaporating within thermomechanical equipment, for example, evaporative cooling equipment, such as evaporative condensers and water evaporative towers, and HVAC systems that include large tanks of water. Some embodiments can also be used to descale pipes and heat exchangers, or mechanical equipment that may have inlays. In some embodiments, the system includes an ionizing device (ion dispenser) with a pair of metal (pure or alloyed) electrodes. These same electrodes can comprise a variable measurement system and a strict control of the treatment can be performed by a controller, which may be a programmable device, such as a programmable logic controller (PLC) or some other type of controller, microcontroller, microprocessor or other similar device. Some embodiments can offer an effective, safe and healthy solution for water treatment and control of scale on metal surfaces.

The advantageous systems and methods described herein may be applied to any mechanical equipment which incorporates water flowing through the equipment. For example, water used within evaporative towers and the associated heat exchangers, evaporative condensers, and other related systems can be treated (e.g., cleaned and descaled) by one or more of the embodiments described herein, along with boilers and other embedded equipment if the water associated with them can be circulated.

In some embodiments, the systems and methods described herein can totally or partially reduce the presence of algae, fungi, bacteria, viruses, and/or biofilm from equipment containing flowing water. By doing so, many diseases, such as Legionella and other infections, can be prevented. Further, the systems and methods can prevent the deposit of carbonate inlays and prevent or eliminate existing calcareous inlays without the use or consumption of chemicals, and without the use or consumption of aggressive chemical treatments commonly used for descaling.

The systems and methods described herein can provide further advantages, such as providing thermal improvements of heat exchangers and/or electrical improvements for treated systems. These improvements can result in lower operating costs versus traditional water treatments, lower energy costs, lower water consumption, no additive costs and biocide, lower maintenance costs of the systems treated versus traditional water treatments, lower replacement costs of heat exchangers, and can extend the useful life of the equipment being treated.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects described herein will become apparent to one of skill in the art from the detailed description and drawings contained herein. Moreover, the various apparatuses and methods described in this summary section, as well as elsewhere in this application, can be expressed as a large number of different combinations and sub-combinations. All such useful, novel, and inventive combinations and sub-combinations are contemplated herein, it being recognized that the explicit expression of each of these combinations is unnecessary.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a perspective view of an exemplary embodiment of an ion dispenser system;

FIG. 2 depicts a lengthwise cross-section of the exemplary ion dispenser of FIG. 1 taken along cross-section 2-2 of FIG. 1;

FIG. 3 depicts a cross-section of the exemplary ion dispenser of FIG. 1 taken along cross-section 3-3 of FIG. 1;

FIG. 4 depicts an end view of an embodiment of an electrode of the exemplary ion dispenser system of FIG. 1;

FIG. 5 depicts a lengthwise cross-section of the electrode of FIG. 4 taken along cross-section 5-5 of FIG. 7;

FIG. 6 depicts a perspective view of the electrode of FIG. 4;

FIG. 7 depicts a top view of the electrode of FIG. 4;

FIG. 8 depicts an exploded assembly view of the ion dispenser system of FIG. 1;

FIG. 9 depicts a schematic view of an embodiment of an exemplary ion dispenser system connected with an evaporative condenser of a refrigeration system;

FIG. 10 depicts a schematic view of an embodiment of an exemplary ion dispenser system connected with a tower and a heat exchanger;

FIG. 11 depicts a schematic view of an embodiment of an exemplary ion dispenser system connected with a boiler;

FIG. 12 depicts a schematic view of an embodiment of an exemplary ion dispenser system connected with a boiler;

FIG. 13 depicts a schematic view of an embodiment of an exemplary ion dispenser system connected with a boiler;

FIG. 14 depicts a schematic view of an embodiment of an exemplary ion dispenser system connected with a boiler; and

FIG. 15 depicts a schematic view of an embodiment of an exemplary ion dispenser system connected with a boiler.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown. Some of the figures shown herein may include dimensions or may have been created from scaled drawings. However, such dimensions, or the relative scaling within a figure, are by way of example and not to be construed as limiting.

### DETAILED DESCRIPTION

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages or may include different benefits or advantages. Any benefits or advantages described herein are not to be construed as limiting to any of the claims.

Likewise, there may be discussion with regards to “objects” associated with some embodiments of the present invention, it is understood that yet other embodiments may not be associated with those same objects, or may include yet different objects. Any advantages, objects, or similar words used herein are not to be construed as limiting to any of the claims. The usage of words indicating preference, such as “preferably,” refers to features and aspects that are present in at least one embodiment, but which are optional for some embodiments.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

Embodiments disclosed herein can provide improved systems and methods for treating water using ionization. Incrustations of salts, specifically calcium carbonate (CaCO3), can present problems when they form on or within water systems, particularly heat exchanger systems utilizing recirculating water supplies. The precipitation and crystallization of salts often generates an insulating layer that hinders heat transfers and decreases the water flow rate. The precipitation can occur on dry or wet surfaces. There can be large and soft crystallization over dry and splashed surfaces.

In some embodiments, the system may be configured to prevent fouling by dosing metal ions into the water. In the water, the salts are dissolved, and the scaling can be broken. Part of the salts may be dissolved and/or changed by cations. Dosing the water with metal ions also was found to increase the solubility of the salts thereby keeping them in an ionic state, and salts which are already retained in scaling formations or calcareous deposits can become anionic by this process. The presence of cations like copper cations (Cu++) or iron cations (Fe++) can make the precipitation of CaCO3 more difficult. The CO3 may be relatively isolated from the calcium cation (e.g., Ca++). In some embodiments, copper cations (e.g., Cu++) may be supplied in an amount of more than about 40 ppm.

The incrustation of calcite bathed or immersed in water presents a balance between solution and precipitation of CaCO3. CaCO3 is more soluble than copper carbonate (CuCO3), iron carbonate (FeCO3), and other common salts. By saturating the water with metal ions which generate more insoluble salts than CaCO3, one can sequester some of the CO3 anions contributed by the slight dissolution. The insoluble metal CO3 molecules provide numerous and dispersed crystallization nuclei for complex crystals to grow, which could crystallize with unstable forms rather than encrusting as calcite. The calcite crystals progressively dissolve and are not replaced by new formations of calcite, which results in a structural weakening of the initial formation. This can result in a significant weakening of the scaling. The mass of added cations and its salts are too small to withstand the flow of the water and the particulates (typically referred to as “mud”) contained within the water. As a result, the scaling can be removed by the flow of the water. Metal ions can be adsorbed on the CaCO3 crystals. Crystallization is mechanically weak and therefore cannot adhere.

The dosing of the metal ions may also inhibit the formation of lime, which may improve the effectiveness of the treatment. Lime is a crystallized calcite which has a block shape and the capacity both to embed itself in materials and to form increasingly thick layers. With cations, other forms and/or complex forms can be found on dry and wet surfaces, while, in the water, there is an increased solubility of scaling. Pipes and systems with existing deposits may require cleaning by scavenging these crystals which, depending on the thickness and hardness, can become totally cleared or dissolved. In conventional systems, if the concentration of salts in the water was increased, then that typically led to a corresponding increase in scaling. However, in embodiments of systems that incorporate an ion dispenser, such as those described herein, the increased solubility can allow for an increase in concentration of salts in the water, without resulting in a corresponding increase in scaling. As a result, for embodiments of systems that incorporate an ion dispenser, such as those described herein, the number of purges required can be reduced, which can reduce the overall amount of water consumed by the water system.

To safely and sensitively treat the fouling conditions as described above, some embodiments of a water treatment system described herein provide a tailored dosage of selected metal ions to the water supply. In some embodiments, the system includes a controller that allows certain variables to be adjusted, either automatically or manually, in order to provide the desired dosage of selected metal ions to the water supply. By treating the water with the most effective metal ion dosage, the system can advantageously prevent new incrustations, eliminate existing incrustations, control algae, bacteria, fungi, and viruses, eliminate the need for handling of liquid chemicals, improve heat transfer by eliminating the insulation layer of incrustations and/or biofilm, reduce energy costs associated with cleaning heat exchangers, reduce maintenance, and prolong the useful life of the equipment. Additionally, as mentioned above, in some applications, automatic water purges can be minimized because, the need for a water purge can be sensed and activated by the system.

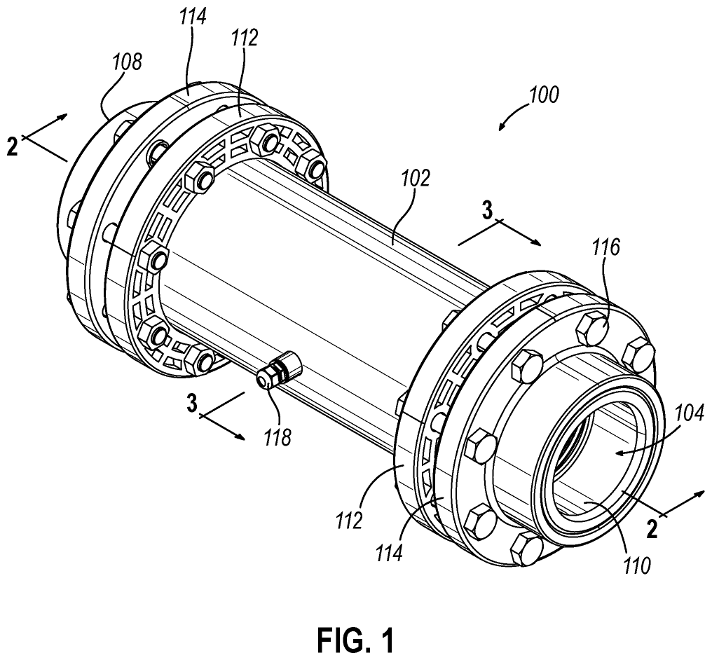

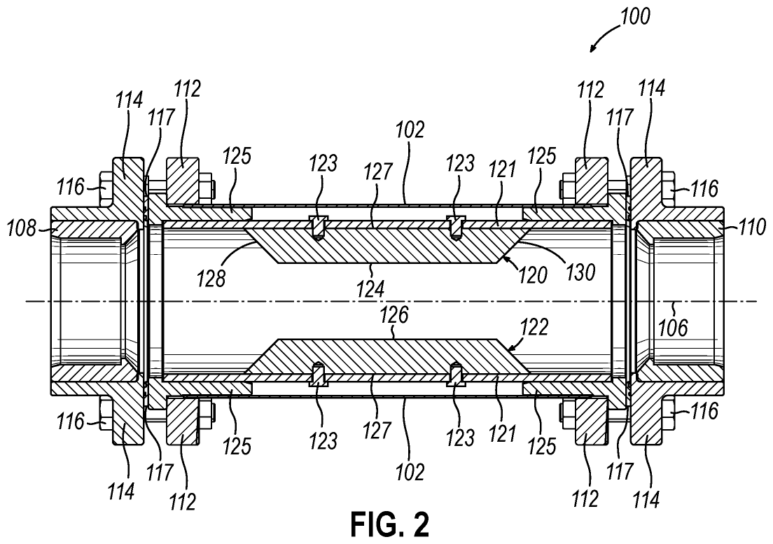

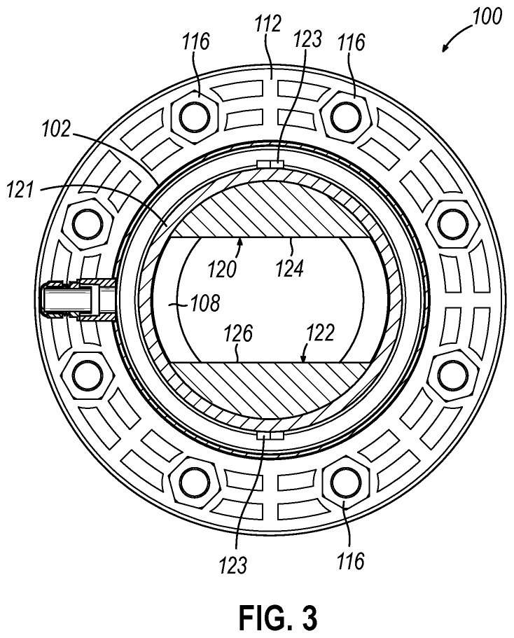

Depicted in FIGS. 1-3 is an embodiment of a metal ion dispenser 100. As shown, the metal ion dispenser 100 includes a housing or outer casing 102. The housing 102 may be made of an electrically insulating and non-corrodible material which is resistant to the temperature at which the treatments will be carried out. For example, the housing 102 may comprise plastic or another suitable material or combination of materials. The entire housing 102 may comprise electrically insulating material to prevent short circuits and force the current to circulate only by the internal electrodes (see, FIGS. 2-3) and the water that flows between them. The dispenser 100 includes a central passageway 104 therethrough along its longitudinal axis 106. At each end is a reducer 108, 110 having an opening allowing fluid (e.g., water) passage through the passageway 104 using the opening of the first reducer 108 as a fluid inlet and the opening of the second reducer 110 as a fluid outlet. At each end of the housing 102 is a flange 112, or flat lap joint, which couples to a cap 114 by one or more connectors (e.g., bolts 116) and including one or more flat seals 117. The cap 114 may be configured to couple the dispenser 100 to pipes of a water system. In this embodiment, the dispenser 100 also includes a connection port 118 for connecting one or more electrical and data interface cables or wires to the dispenser 100. These cables or wires may allow the dispenser 100 to communicate with a control system.

Depicted in FIGS. 2-3, the metal ion dispenser 100 includes a pair of electrodes 120, 122 connected to a power supply. The electrodes may be affixed to a round internal pipe 121 positioned within the housing 102 using one or more fasteners 123. Fasteners 123 may comprise screws or any other suitable fastener and may be inserted into openings 134 in electrodes 120, 122. In some embodiments, pipe 121 may be omitted and electrodes 120, 122 may instead be affixed directly to housing 102. For example, such a construction may be used in larger applications, such as when the inner diameter of the housing is about 60 inches.

As shown, electrodes 120, 122 are positioned opposite each other between the fluid inlet and the fluid outlet of the ion dispenser 100. In some embodiments, such as those intended to be used in normal temperature settings, the internal pipe 121 may comprise a plastic or other suitable material. Examples of suitable plastics include, but are not limited to, polyvinyl chloride (PVC), polypropylene (PP), and fiber-reinforced plastic (FRP). In some embodiments, a normal temperature setting may be between about 20 and about 50 degrees Celsius and in those embodiments the internal pipe 121 may comprise PVC, PP, FRP or other similar materials. In embodiments intended to be used in high-temperature settings, the internal pipe 121 may comprise a high temperature-resistant and electrical insulator material, including but not limited to an epoxy composite. In some embodiments, a high temperature setting may be at or above 90 degrees Celsius and in those embodiments the internal pipe 121 may comprise a high temperature-resistant material, such as an epoxy composite. Internal pipe 121 can also comprise a metal tube with an insulator layer resistant for high temperature. In embodiments wherein the internal pipe includes a high temperature-resistant material, the ion dispenser 100 can clean boilers or other similar equipment which are in service using high temperature heat exchangers. For these types of high temperature applications, in addition to utilizing high temperature-resistant materials for the internal pipe 121, the standard electric wiring (used for energy supply) can also be modified with high temperature wires or 100% metal bare wire (without PVC or silicone covers). Additionally, the space between the internal pipe 121 and the housing 102 can be empty or filled with specifically tailored resins designed to function at high temperatures and/or pressures. The filling can improve the sealing in case of worn electrodes. In these applications, one or more of the other components of the ion dispenser 100, such as reducers 108, 110, flanges 112, caps 114, flat seals 117, and flange holders 125 can also comprise material suitable for such a high temperature application.

Further, the housing 102 and the internal pipe 121 may be separated by one or more flange holders 125. In some embodiments, electrodes 120, 122 comprise copper or some combination of materials that includes copper. In other embodiments, the electrodes 120, 122 can comprise other suitable materials or combinations of materials. When electrical charge is applied to the electrodes, one electrode acts as an anode and the other electrode acts as a cathode. The low voltage electric force imparted to the circulating water disassociates some of the hydrogen and oxygen molecules making up the water to create dissolved hydrogen gas, oxygen gas, and free hydrogen ions. At the face of the electrodes, positively charged metal ions are discharged into the water stream. The electrical current intensity provided by the electrodes 120, 122 can be adjusted to dose the required number of ions according to the selected treatment intensity.

In some embodiments, the electrical polarity of the potential difference between the electrodes 120, 122 may be reversed at regular intervals to minimize certain adverse electrolytic effects, such as selective deposition on an electrode, premature anode depletion (by virtue of the passage of metal ions to solution), and other similar asymmetric effects, which would lead to the need to replace the electrodes more frequently. In some embodiments, this reversal may occur every hour or at some other desired interval. During the polarity inversions, there is a period of zero potential. When the power supply is turned off, in the period of zero potential the voltage decreases progressively. In some embodiments, the polarity reversal may be done automatically by the controller, while in other embodiments the polarity reversal may be manually controlled by the user, and in still other embodiments the polarity reversal may be able to be controlled both automatically and manually.

In some embodiments, the current density that circulates through the electrodes can be very low, for example, approximately less than about 1 milliamp per square millimeter or another suitable current density. This can reduce the effect of deposits that contaminate the electrodes which, in turn, can reduce the effectiveness of the ion dispenser 100. Deposits on the cathode are typically carried away by the high-velocity water flow and these particles provide additional nuclei of crystallization and other electrochemical actions. In some embodiment, the water flow can be at about two meters per second. However, it should be understood that the velocity of the water flow can be increased or decreased depending on the particular specifications of the particular application.

Salts, such as calcium carbonate, vary their solubility in water depending on the temperature, pH, and other characteristics of the water. Calcium carbonate reduces in solubility as its temperature rises, thereby generating incrustations in any hot spots. When the concentration is greater than the saturation, the salts can precipitate. When the concentration is less than saturation, the salts can dissolve. If dissolved anions are removed from the periphery of a scale incrustation, the concentration of scale can be lowered. The incrustation provides replenishment to saturation and loses molecules that give it structural strength. After some time, the degraded incrustation loosens and can be removed.

Certain metal ions (e.g., Ag++, Cu++, Fe++, Mn++, Zn++) in aqueous solutions combine with anions of carbonates, silicates, and other substances that may be present and available in the solution. One particular experiment related to this concept examined the interaction between iron and calcium and the results are described in a thesis titled “Effect of Calcium (II) and Iron (II) on the Precipitation of Calcium Carbonate and Iron Carbonate Solid Solutions and on Scale Inhibitors Retention” by Alsaiari (Rice University, 2011). The entire disclosure, except for any definitions, disclaimers, disavowals, and inconsistencies, is incorporated herein by reference.

The metal ions are dispersed in the totality of the water of the treated circuit by the Brownian movement and are enhanced by the repulsion of the electric charge they possess. Carbonates of these metals are more insoluble than calcium carbonate and magnesium.

TABLE 1
Solubility of Metal Carbonates

| | | Solubility in |
|---|---|---|
| | | Water @ 20° C. |
| Metal Carbonate | Formula | (g/mL) |
| Potassium carbonate | K2CO3 | 111 |
| Rubidium hydrogen carbonate | RbHCO3 | 110 |
| Ammonium carbonate | (NH4)2CO3•H2O | 100 |
| Potassium hydrogen carbonate | KHCO3 | 33.7 |
| Ammonium bicarbonate | NH4HCO3 | 21.7 |
| Sodium carbonate | Na2CO3 | 21.5 |
| Calcium bicarbonate | Ca(HCO3)2 | 16.6 |
| Sodium hydrogen carbonate | NaHCO3 | 9.6 |
| Lithium bicarbonate | LiHCO3 | 5.74 |
| Gadolinium(III) bicarbonate | Gd(HCO3)3 | 5.61 |
| Thallium(I) carbonate | Tl2CO3 | 5.3 |
| Lithium carbonate | Li2CO3 | 1.33 |
| Beryllium carbonate | BeCO3 | 0.218 |
| Magnesium carbonate | MgCO3 | 0.039 |
| Silver carbonate | Ag2CO3 | 0.003489 |
| Barium carbonate | BaCO3 | 2.40E−03 |
| Strontium carbonate | SrCO3 | 0.0011 |
| Nickel(II) carbonate | NiCO3 | 9.64E−04 |
| Calcium carbonate (Aragonite) | CaCO3-Aragonite | 7.75E−04 |
| Calcium carbonate (Calcite) | CaCO3-Calcite | 6.17E−04 |
| Copper(II) carbonate | CuCO3 | 1.46E−04 |
| Lead(II) carbonate | PbCO3 | 7.27E−05 |
| Iron(II) carbonate | FeCO3 | 6.55E−05 |
| Manganese(II) carbonate | MnCO3 | 4.88E−05 |
| Zinc carbonate | ZnCO3 | 4.69E−05 |
| Cadmium carbonate | CdCO3 | 3.93E−05 |
| Mercury(I) carbonate | Hg2CO3 | 4.35E−07 |

The molecules (salts) of copper, manganese, iron and zinc carbonates, being more insoluble in water than calcium carbonate, can sequester carbonate anions, weakening the incrustations and serve as nuclei of crystallization, complexation, and coagulation. The molecules (salts) of lead, cadmium, and mercury carbonates are composed of toxic/contaminating elements and should be avoided.

The cations dosed to the body of water via an ion dispenser, such as ion dispenser 100 described herein, may have one or more of the following characteristics: (1) they do not increase their concentration proportionally to the ionic contribution in the water while there are organic matter and inlays, (2) they combine with the biomass of water, (3) some (e.g., copper) are aggressive with algae and bacteria, (4) some combine with free anions, forming insoluble salts, (5) as salts are more stable than calcium and magnesium carbonates, the salts sequester the calcium, magnesium carbonate, and bicarbonate anions in solution, (6) the dissolved carbonates may weaken the scaling, (7) molecules of the salts precipitate as mud and parts of the weakened scaling break and drop as mud, (8) molecules of the salts serve as crystallization nuclei, (9) some cations push to form complex crystals, (10) some cations are free in certain concentrations according to the ion, temperatures, other substances in the water, and other conditions, (11) the cations, due to their electrical charge, repel and keep the dissolved salts dispersed, thereby increasing the solubility and conditioning the crystallization, (12) increased solubility facilitates descaling; and (13) the new crystal formations are soft and therefore not encrusting. Copper ions may provide dual benefits of creating a strong biological action and increasing the removal of the encrusting carbonates.

It may be advantageous to be able to dose a particular amount or flow of ions which is capable of inhibiting and reversing the incrustation process. As such, the electrode current and the size/mass of the electrodes can be selected to provide the desired amount of ions for a given application.

In some embodiments, the power supply is configured to provide power (e.g., electricity) to the ion dispenser 100 so that the electrodes provide power at a predetermined current level (amps) to the fluid flowing through ion dispenser 100, which may facilitate the treatment being stable over time, regardless of the wear of the electrodes 120, 122. In some embodiments the power provided to the ion dispenser 100 by the power supply is direct current. That is, in these embodiments, instead of providing power to the ion dispenser 100 to maintain a particular voltage level (i.e. a potential energy differential level) between electrodes 120, 122, for example, 20 volts, 24 volts, or x volts, a user or the system can instead select the desired current level to be applied by the electrodes 120, 122 to the fluid. Then, through the connected controller, the power being provided by power supply can be adjusted so that the voltage required to obtain the predetermined current level is created between electrodes 120, 122. Further, the controller can control or communicate with the power supply in order to adjust the value of the predetermined current level at regular intervals (in some embodiments, every second, minute, or hour), continuously or stepwise, such that different treatment intensities may be available, depending on the size or condition of the equipment to be treated.

The formula R=ρ*(L/S) can be applied to the set of electrodes 120, 122 in ion dispenser 100. In this formula, R represents resistance, p represents the conductivity of the aqueous solution between the electrodes, L represents the separation of the electrodes, and S represents the exposed surface of the electrode to the fluid or saline solution. As such, the geometry of the electrodes is such that the resistance increases slightly as the electrodes wear during use. This geometry allows the power supply to continue providing power to the electrodes to produce the predetermined current level in a manner which is manageable by the power supply. More particularly, in the “L/S” relationship, the possibility of variation of the separation and surface and the influence of both on the need for applied voltage is not significant. The power supply can adjust the voltage between the first electrode and the second electrode so that the electrodes apply current to the fluid at the predetermined current level. The “L/S” relationship can be handled by the geometry of the face and by the length of the electrode. In the illustrated configuration, the length is not limited other than for reasons of cost and handling.

As depicted in FIGS. 2-3, the inward (fluid-facing) faces 124, 126 of each electrode 120, 122 are substantially planar. The substantially planar design of the faces 124, 126 of the electrodes 120, 122 minimize the “wet perimeter” or resistance to water flow. Further, the outward (housing-facing) faces 127, 129 of each electrode 120, 122 are curved or rounded to complement the interior surface of the internal pipe 121. The curved or rounded design of the faces 127, 129 of the electrodes 120, 122 facilitate a flush placement against the interior surface of the internal pipe 121, therefore restricting fluids from flowing between the outward faces 127, 129 of the electrodes 120, 122 and the interior surface of the internal pipe 121. Other shapes for the electrodes and their respective faces may be used depending on the particular application.

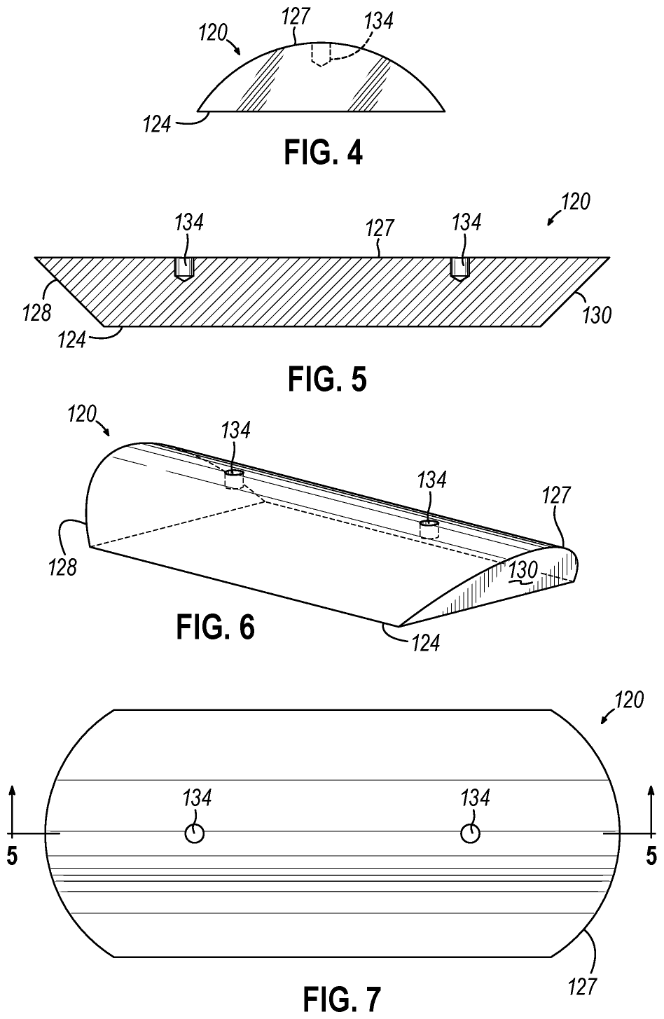

As depicted in FIGS. 4-7, the first side surface 128 of the electrode 120, 122 facing the fluid inlet and the second side surface 130 of the electrode 120, 122 facing the fluid outlet is angled and/or curved such that the fluid dynamic resistance is minimized. In the illustrated embodiment, the angles of the side surfaces 128, 130 are about 45 degrees with respect to the planar face 124. In some embodiments, the angles of the side surfaces 128, 130 may be within a range of about 30 degrees to about 60 degrees. In still other embodiments, the angles 132 may be other suitable angles below about 30 degrees or above about 60 degrees depending on the particular application. In some embodiments, the electrode includes a radius of curvature in the union of the faces to reduce the fluid detachment effect. The circular segment shape of the electrode allows the entire inner surface section of the ion dispenser to be used with an electrode mass, thereby increasing the available mass.

Further as depicted in FIGS. 4-7, inward face 124, 126 of each electrode 120, 122 may be shorter than the corresponding outward surface 127, 129 of the respective electrode 120, 122. By way of example only, in one embodiment, the inward face 124 can be about 190 millimeters long while the outward face 127 can be about 250 millimeters long. In another example, the inward face 124 can be about 108 centimeters long while the outward face 127 can be about 120 centimeters long. However, it should be understood that planar face 124 and curved rear surface 127 may be other suitable sizes depending on the particular application.

As shown, each electrode 120, 122 also includes one or more fasteners, such as screws 123, which can also provide the electrical connection to the electrodes 120, 122. Some embodiments may also include an adhesive and/or sealing material around the fasteners. The adhesive and/or sealing material may help keep the electrodes in position over time during use.

According to the electrical conductivity of the liquid and the configuration of the electrodes 120, 122 (e.g., the surface exposed to water, the separation of the same, and the consumption or wear of electrodes that progressively increases the separation), the electrical resistance or conductivity can vary.

In some embodiments, the electrodes 120, 122 form part of the conductivity and conductance measurement system, without needing a specific sensor for these variables. These values are necessary for an automatic adjustment of the system. Because the system equipment can control the salt concentration by means of automatic or manual purges, the system is capable of adjusting or controlling the electrical conductivity of the fluid.

As the electrodes 120, 122 are utilized during operation they can wear, which can cause the separation of the electrodes to increase. As the value “L” in the above formula increases, the resistance to stable conductivity increases as well. However, since the system can increase the salt concentration, it can therefore sustain the resistance value of the system within the parameters that the equipment requires to dose the desired ionic flux. To avoid an excessive concentration of salts, the voltage of the power being provided by the power supply can be increased automatically to compensate for the increased resistance due to wear. Because of this, the system can also sustain the ionic flow stability.

This two-fold capability of adjusting the circulating current by the conductivity of the liquid and by the applied voltage may provide advantageous flexibility to adapt the treatment to different and varying conditions. Further, because the treatment is effective at low voltages (such as, for example, between about 10 and about 24 volts), the system remains safe for operators.

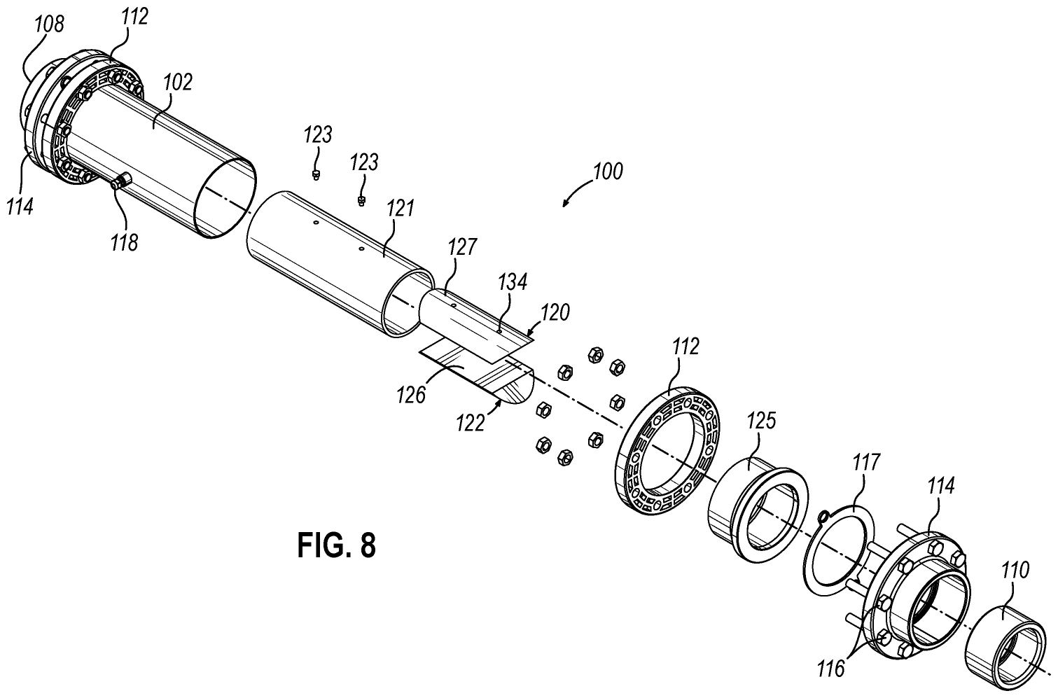

FIG. 8 an exploded assembly view of the dispenser 100 shown in FIGS. 1-3. An exemplary method of assembling ion dispenser 100 can include assembling the internal pipe 121 with the electrodes 120, 122, and connecting one or more connection cables (e.g., electrical and data interface cables or wires) to dispenser 100 via one or more connection ports, such as connection port 118. Next, the method can include applying an adhesive (not shown) to the outer surface of the internal pipe 121, inserting a first flange holder 125 on the end of the internal pipe 121, threading the flanges 112, and inserting the internal pipe 121 into the housing 102. Next, the method can include inserting a second flange holder 125 on the opposing end of the internal pipe 121 and affixing the second flange holder 125 with an adhesive. Next, the method can include placing the flat seals 117 and caps 114, before applying adhesive and inserting the reduction sleeves 108, 110. Finally, the bolts 116 can be tightened, and a leak test can be performed. Of course, other suitable methods of assembling an ion dispenser and/or installing an ion dispenser with a water system may be utilized based on the teachings disclosed herein.

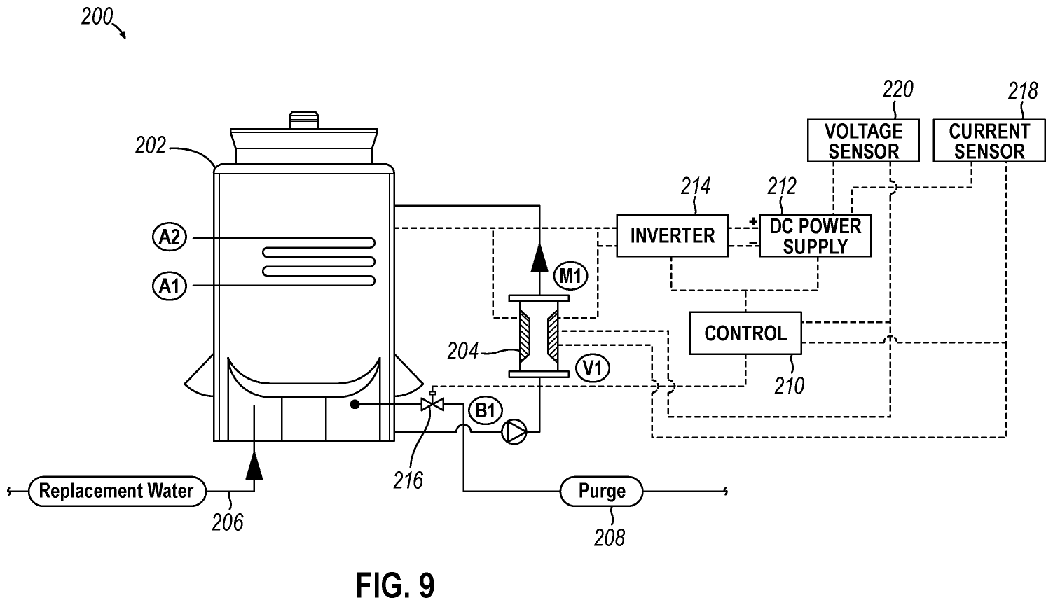

As illustrated in FIG. 9, in some embodiments, the system includes a controller configured to control various aspects of the ion dispenser and other components of the system in order to apply the desired level of treatment to the fluid flowing through the system. In some embodiments, there may be a controller for each ion dispenser. In other embodiments, that include several ion dispensers, a particular controller can control the operation of more than one ion dispenser. The controller can comprise a programmable device, such as a PLC, along with sensors and other components, such as power supplies associated with one or more of the ion dispensers. In some embodiments, the system may include independent power supplies configured to provide power to each of the ion dispensers independently of one another. In some embodiments, the controller, and subsequently the components included in the system, can be monitored and operated remotely by an electronic device (e.g., a server, computer, smartphone, or any other similar device) via a data connection over a wired or wireless network.

At the beginning of descaling treatments in highly embedded equipment or pipes, a particular treatment intensity may be required, such as one with higher ion flow. Once the equipment is descaled, the ion flow can be reduced to a “maintenance level” to prevent scaling and prevent the growth of the biomass. As such, embodiments of the ion dispenser and related systems are capable of adapting to both scenarios, performing shock treatments or maintaining the minimum maintenance treatment. To alter the ion flow, the electrical current may be modified. For example, the electrical current can be applied between 1 and 100 amps. Depending on the size and other variables discussed herein of the water treatment system, it should be understood that the electrical current can be less than 1 amp or more than 100 amps, as necessary.

During the minimum maintenance treatment, electrical power can be reduced, which will also reduce electrode consumption. With a lower consumption of electrodes, less free metal ions are evacuated in the effluent water therefore resulting in a decreased environmental impact when compared to traditional chemical water treatments. The systems and processes described herein are not corrosive with the metals of the equipment and pipelines subjected to cleaning. The deterioration of the equipment and pipelines due to corrosion by chemical treatments can be reduced or avoided.

As the temperature does not influence the system's effectiveness, embodiments of the ion dispensers can be installed in water systems that utilize both hot water and cold water and water systems located both indoors and outdoors.

As will be illustrated in various embodiments described below, an exemplary water system can include one or more of, but not limited to, the following components: (1) an ion dispenser, (2) a controller, (3) a power supply, (4) a current sensor, which can inform the controller of the circulating electric current being applied to the fluid by the electrodes, (5) a voltage sensor, (6) a purge valve, (7) electrical wiring, and (8) piping.

As depicted in FIG. 9, one exemplary water system 200 includes an evaporative condenser 202 that could be part of a refrigeration system. As shown, water system 200 also includes: (1) an ion dispenser 204 connected in series with the water recirculation circuit, (2) a water replenishment line 206 with a float to compensate for the evaporated water, (3) a purge/discharge pipeline 208 with a purge valve 216 that can be activated by a controller 210 which may comprise one or more controllers, such as programmable logic controllers (PLCs), microcontrollers, microprocessors or other similar devices, (4) a stable and continuous power supply 212 which delivers constant direct current, wherein the controller 210 regulates the voltage of electrodes in ion dispenser 204 so that the deliver current at a predetermined current level to the fluid flowing through ion dispenser 204, (5) a current sensor 218; and (6) a voltage sensor 220. The current sensor and voltage sensor may be configured to provide input to the controller 210 in order to allow the controller to regulate the voltage between the electrodes to ensure the power is being applied to the fluid at the predetermined current level.

By monitoring the values of current and voltage between the electrodes, one can calculate the conductivity of the water and the conductance/resistance of the ion dispenser, which depend on the concentration of salts and geometry of the electrodes. In some embodiments, the controller can be programmed to be initiate a purge of the water system when a designated parameter, such as the voltage between the electrodes, reaches a predetermined threshold level. For example, the water may be purged from the system if the electrical resistance reaches or surpasses a predetermined threshold level set by the user and/or determined by the controller or if the current and/or voltage between the electrodes in the ion dispenser drops below a predetermined threshold level set by a user and/or determined by the controller. Each threshold could be, for example, defined by a predetermined resistance rise or current/voltage drop ratio when compared with the resistance, current, and/or voltage at an earlier designated time, such as the time of the initial system setup. As shown in FIG. 9, the system 200 may also contain a current inverter module 214 configured to alternate the polarity of the electrodes in the ion dispenser 204. As discussed above, alternating the polarity of the electrodes in the ion dispenser may facilitate uniform wear on the electrodes. As such, the system 200 is regulated by a monitoring and control system, including controller 210 and associated sensors, that allows the complete management of the water treatment process. Although not required, in some embodiments the system may include a filtering module configured to control and remove solids which may be present in the system.

In some embodiments, the electrodes can be as long as necessary for a particular application. In addition, the components of the ion dispenser can have a diameter which closely correlates to the diameter of the inlet piping. The size and mass of the electrodes can then be dimensioned quadratically depending on the diameter of the housing in accordance with various rules of geometry. Other parameters may also be varied, such as the separation of the electrodes and the length of the electrodes to achieve the required mass. For example, for large applications, each electrode could have a mass of about 1 kg to about 1000 kg. Some embodiments of the ion dispenser can comprise an inlet diameter of between about 20 to about 60 inches or more, which can allow ion dispenser to be used in systems that include large cooling towers that process about 10,000 cubic meters of water flow or more per hour. Alternatively, in some cases, ion dispensers having smaller diameters and smaller electrodes can be combined in series or parallel to solve other unique dosing cases.

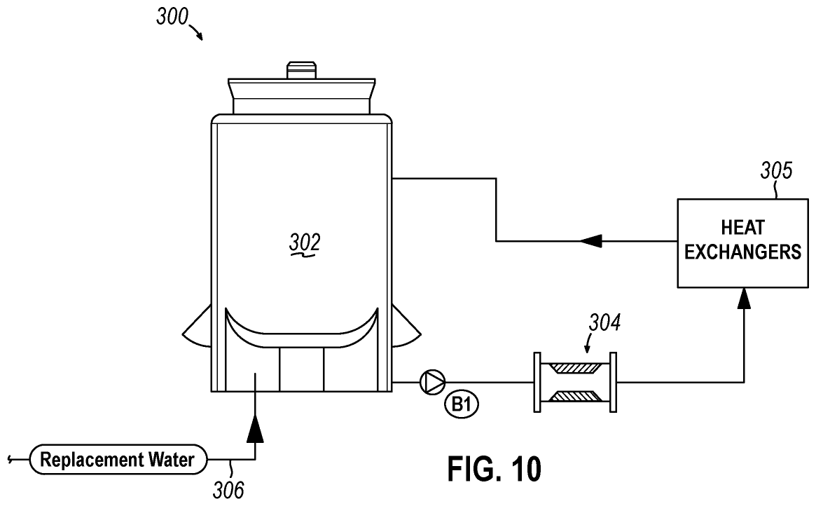

Depicted in FIG. 10 is another embodiment of a water system 300 that includes an ion dispenser 304. In this embodiment, water system 300 also includes a cooling tower 302 and other associated components, such as heat exchangers 305, in fluid communication with ion dispenser 304. The ion dispenser 304 is positioned between and in fluid communication with the cooling tower 302 and other associated components, such as the heat exchangers 305. The heat exchangers can be positioned as illustrated or in any other suitable arrangement within the system. The embodiment shown in FIG. 10 may also include a purge line with an associated purge valve, a water replenishment line 306, a controller, an inverter, and a power supply, similar to purge/discharge pipeline 208, purge valve 216, controller 210, power supply 212, and inverter 214 shown in FIG. 9 and described above.

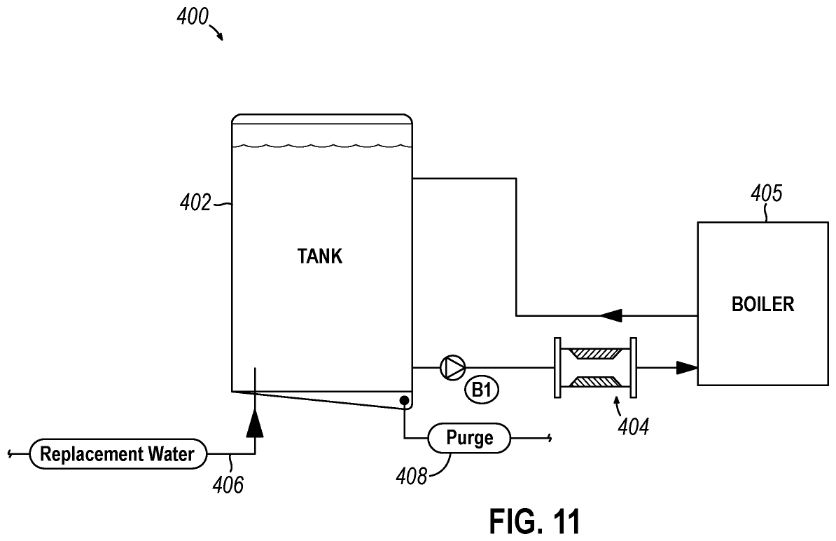

Depicted in FIG. 11 is another embodiment of a water system 400 that includes an ion dispenser 404. In this embodiment, water system 400 includes a boiler 405 and an associated water tank 402. The ion dispenser 404 is positioned between and in fluid communication with the boiler 405 and the water tank 402. In the illustrated embodiment, tank 402 includes a purge line 408 that may be similar to purge/discharge pipeline 208 described above. The embodiment shown in FIG. 11 may also include a purge valve associated with purge line 408, a water replenishment line 406, a controller, an inverter, and a power supply, similar to purge valve 216, controller 210, power supply 212, and inverter 214 shown in FIG. 9 and described above.

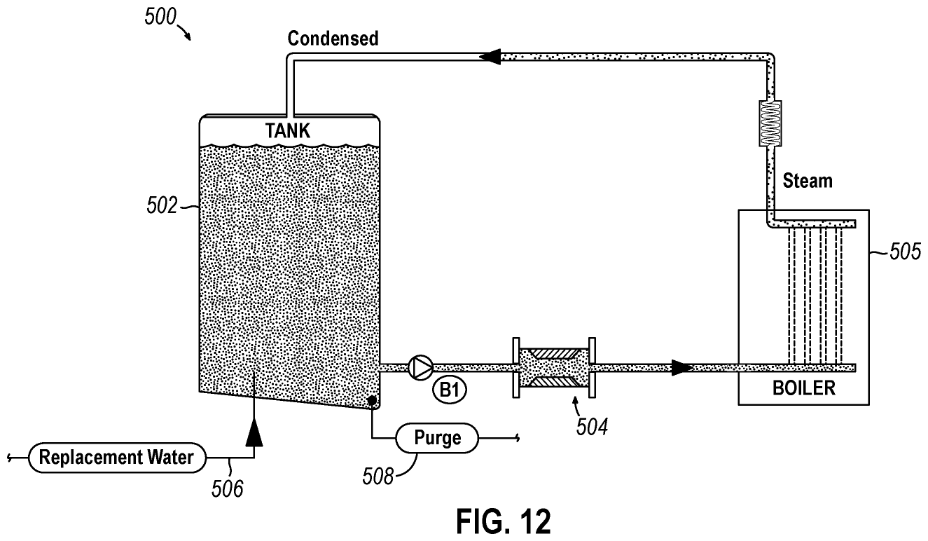

Depicted in FIG. 12 is another embodiment of a water system 500 that includes an ion dispenser 504. In this embodiment, water system 500 also includes a boiler 505 and an associated water tank 502. The ion dispenser 504 is positioned between and in fluid communication with the boiler 505 and the water tank 502. In the illustrated embodiment, tank 502 includes a purge line 508 that may be similar to purge/discharge pipeline 208 described above. In addition, the embodiment shown in FIG. 12 may also include a purge valve associated with the purge line, a water replenishment line 506, a controller, an inverter, and a power supply, similar to purge valve 216, controller 210, power supply 212, and inverter 214 shown in FIG. 9 and described above.

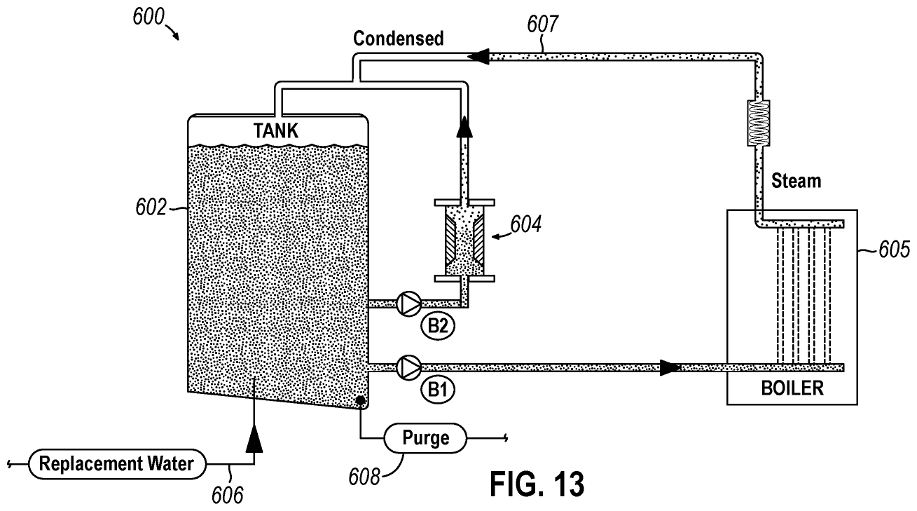

Depicted in FIG. 13 is another embodiment of a water system 600 that includes an ion dispenser 604. In this embodiment, water system 600 also includes a boiler 605 and an associated water tank 602. The ion dispenser 604 is positioned in an alternative position within the system, relative to water system 500 shown in FIG. 12. Specifically, instead of being in direct fluid communication with the boiler 605 similar to the embodiment shown in FIG. 12, in system 600 the ion dispenser 604 is in fluid communication with the return piping 607 that allows fluid to flow from the boiler 605 back to the tank 602. In the illustrated embodiment, tank 602 includes a purge line 608 that may be similar to purge/discharge pipeline 208 described above. In addition, the embodiment shown in FIG. 13 may also include purge valve associated with the purge line 608, a water replenishment line 606, a controller, an inverter, and a power supply, similar to purge valve 216, controller 210, power supply 212, and inverter 214 shown in FIG. 9 and described above.

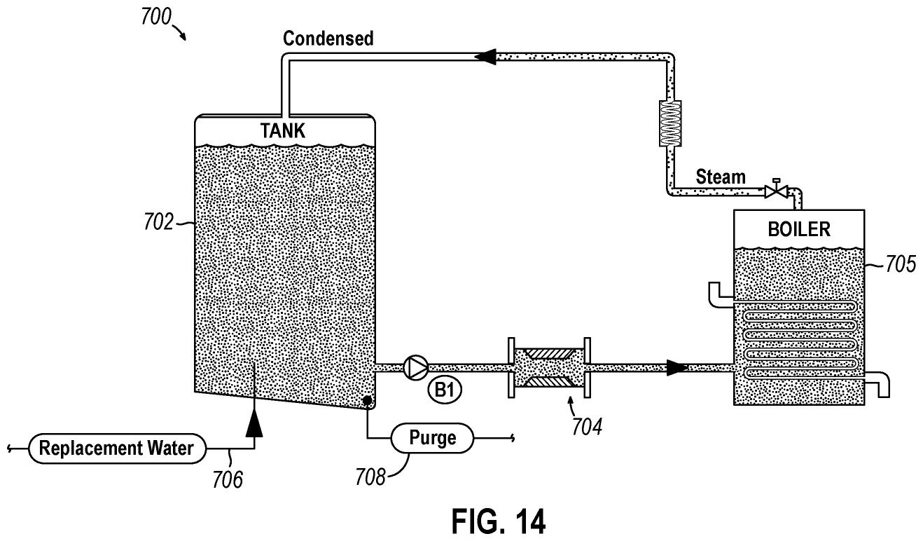

Depicted in FIG. 14 is another embodiment of a water system 700 that includes an ion dispenser 704. In this embodiment, water system 700 also includes a boiler 705 and an associated water tank 702. The ion dispenser 704 is positioned between and in fluid communication with the boiler 705 and the water tank 702. In the illustrated embodiment, tank 702 includes a purge line 708 that may be similar to purge/discharge pipeline 208 described above. In addition, the embodiment shown in FIG. 14 may also include purge valve associated with the purge line 708, a water replenishment line 706, a controller, an inverter, and a power supply, similar to purge valve 216, controller 210, power supply 212, and inverter 214 shown in FIG. 9 and described above.

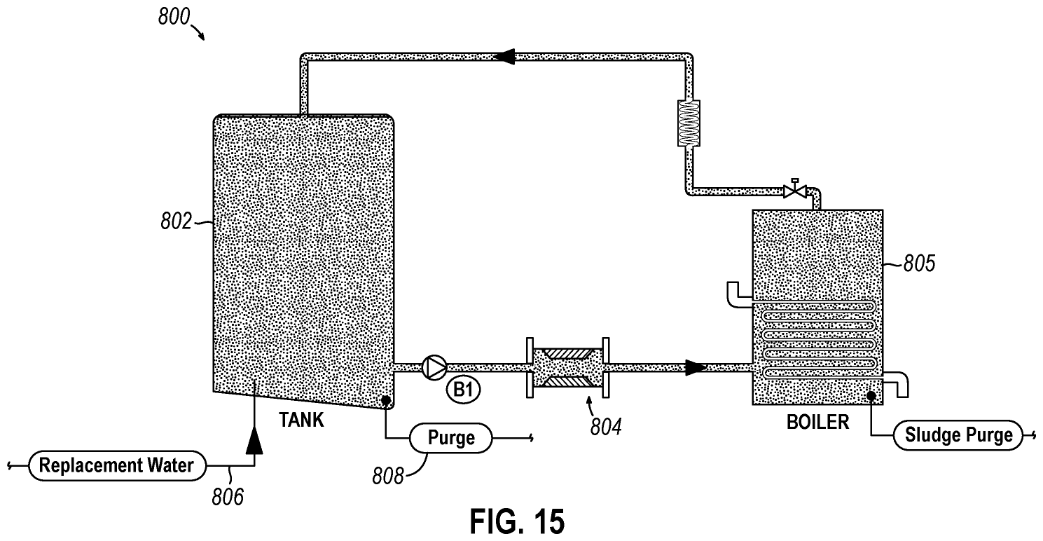

Depicted in FIG. 15 is another embodiment of a water system 800 that includes an ion dispenser 804. In this embodiment, water system 800 also includes a boiler 805 and an associated water tank 802. The ion dispenser 804 is positioned between and in fluid communication with the boiler 805 and the water tank 802. In the illustrated embodiment, tank 802 includes a purge line 808 that may be similar to purge/discharge pipeline 208 described above. In addition, the embodiment shown in FIG. 15 may also include purge valve associated with the purge line 808, a water replenishment line 806, a controller, an inverter, and a power supply, similar to purge valve 216, controller 210, power supply 212, and inverter 214 shown in FIG. 9 and described above.

As described above, in some embodiments, the water system may include a purge valve. The purge valve can be used to help keep the conductivity of the water in a desirable range, thereby allowing the ion dispenser to function properly. This purge valve can be a “ball” type, or, in general, any valve with an open channel for the purged water. One such valve, for example, is the B224VS+AFBUP-X1 which is sold by Belimo Aircontrols, Inc. Because the system may be installed outside, the valve may function more effectively when it is an IP 65 (Ingress Protection) rating or greater. For certain embodiments, an IP 67 rated device with a UV cover protector may be preferred. One example is the A20-T Series Electric Shut Off Ball Valve which is sold by Taizhou Tonhe Flow Control Equipment Co., LTD. While some applications will allow for the use of servo type valves as the purge valve, other types of valves may be beneficial in other applications. For example, in some applications, the purge valve may need to purge while using only a small difference in height. In these applications, it may be beneficial to incorporate a purge valve that is actuated by pneumatic pressure or electric motor.

As has been illustrated in the figures and described herein, the exemplary water systems and methods may include any or all of the following attributes, features, and potential benefits in varying combinations:
(1) The power supply can be configured to automatically adjust the voltage between the electrodes to maintain a predetermined current value. The current level is directly linked to the intensity of the treatment, and the treatment is stable according to the selected current level.
(2) The controller can monitor and control more than one ion dispenser.
(3) Ion dispensers can be combined in series or parallel to achieve the appropriate dose in some applications.
(4) The length, curved face diameter, thickness or sagitta, separation, and weight of each electrode can be adjusted for each application.
(5) The dimensions and shapes of the electrodes can be such that they allow working with low current density, such as approximately less than one milliamp per square millimeter or other suitable densities, which can help prevent the accumulation of deposits on the cathode.
(6) The system can include an inverter configured to invert the polarity of the electrodes at regular intervals, which can help prevent the accumulation of deposits on the electrodes and promote even wear of the electrodes.
(7) Light deposits can easily be swept away by water flow.
(8) There can be an adjustable duration of pause having zero voltage applied to the electrodes between polarity inversions.
(9) The geometry can be such that, with worn electrodes, the resistance/conductance variation of the ion dispenser is not significant and can be calculated and allows the power supply to continue, at regular intervals, providing and adjusting the power to create the desired circulating current level.
(10) When the electrodes are partially worn, the resistance increases, and the power supply can compensate for that wear and greater resistance with higher applied voltage between the electrodes.
(11) When the electrodes are partially worn, the separation between the faces exposed to the fluid increases. As the system controls the purges, it can increase the salts in solution and the electrical conductivity, such that the resistance of the ion dispenser remains within the operating range of the power supply, for the predetermined current level.
(12) Each electrode can comprise the same metal or metal alloy as the other electrode.
(13) The mass of the electrodes can be such that it allows the ion dispenser to operate for approximately one year, which can minimize maintenance and/or replacements.
(14) Because the intensity of the treatment can be easily adjusted with the intensity of the ionic flow, the system allows for initial shock treatments at a higher ionic flow followed by maintenance treatments at a lower ionic flow.
(15) The controller can be configured to allow a user to select the period of time (e.g., days, hours, etc.) in which the high intensity shock treatment will be carried out.
(16) The controller can be configured to allow a user to select the intensity of the treatment.
(17) The adjustment of treatment intensity allows only the required ionic mass to be used, thereby reducing costs of replacement and evacuation of unnecessary metal ions in effluent water.
(18) The shape of the electrodes at the inlet and outlet of the equipment can be configured such that the electrodes decrease the fluid dynamic resistance of the water, the pressure losses, and pumping power required to move the water through the system.
(19) The treatment system may use the equipment geometry and circulated current to calculate the wear of the electrodes in the ion dispenser.
(20) According to the resistance or conductance, an operator or the system itself can determine whether the conductivity is within the desired range and initiate a purge if necessary to bring the conductivity within the desired range.
(21) Purge start detection: If the applied voltage falls below a predetermined purge threshold level, that may indicate that the salts have been concentrated in excess and the system can initiate (either automatically or manually) a purge and replenishment process with new water.
(22) Purge end detection: After a purge is initiated, if the applied voltage rises to a value above a predetermined purge threshold level, that may indicate that the concentration of salts has been reduced to an acceptable value and the system can complete and terminate the purge process.
(23) Detection of worn electrodes: The control system can track the electrical current over a period of time. The tracked electrical current can be used to calculate the mass of the electrode to help determine whether each electrode is partially worn. Faraday's law may be used to make such calculations. If the remaining mass of an electrode is lower than a threshold mass, the system can generate an alert to indicate the worn state of the electrode.
(24) Detection of dirty electrodes: When the supply voltage rises above a predetermined wear threshold while trying to sustain the selected treatment circulating current level, the system can automatically determine, or an operator can manually determine, that the electrode is dirty. In such a situation, the controller may provide feedback to the user, such as an audible or visible indicator, to indicate that an electrode may need to be cleaned.
(25) Autocleaning for the purge valve: The water with a high concentration of salts can stick to the purge valve. In these instances, the controller can be configured to initiate an OPEN-CLOSE or a CLOSE-OPEN sequence for the purge valve. This movement can help clean the salts on the valve, therefore preventing locking of the purge valve.
(26) Detection of blocked purge: If the voltage drops below a predetermined level such that the system cannot provide power to produce the selected circulating current level, this could indicate that the purge valve is blocked. In these situations, the controller can be configured to provide feedback to the user, such as an audible or visible indicator, that the controller cannot purge the system as planned.
(27) Free metal ions increase the solubility of salts in water, preventing their crystallization and helping to dissolve existing scaling.
(28) Free metal ions condition the crystallization process of calcium carbonate into unstable and soft forms.
(29) To modify the lime to other non-encrusting crystals, metal ions are dosed in sufficient quantities.
(30) Through the supplied current, the system or an operator can verify and/or correct for the flow of ions provided to achieve an effective treatment.
(31) Copper ions achieve a combined effect of bactericide, algaecide, and antifouling.
(32) Other metal ions have a complementary effect.
(33) The controller can be configured to provide a user with indicators of its states through various protocols and can also be controlled remotely.
(34) The treatment system can include internal components made to withstand high temperatures and the electrical insulator material can be modified to be suitable and safe for the high temperature application.
(35) Electrical connection between the power supply and the ion dispenser can be made by metal bars.
(36) The interior of the ion dispenser can be filled by high temperature resins and/or composites selected to improve sealing and electrical insulation.

Reference terms that may be used herein can refer generally to various directions (e.g., upper, lower, forward and rearward), which are merely offered to assist the reader in understanding the various embodiments of the disclosure and are not to be interpreted as limiting. While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used or applied in combination with some or all of the features of other embodiments unless otherwise indicated. One or more exemplary embodiments have been shown and described, and all changes and modifications that come within the spirit of the disclosure are desired to be protected.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

What is claimed is:

1. A method of treating water, comprising:
(a) providing a water system, wherein the water system comprises an ion dispenser, wherein the ion dispenser includes a first electrode and a second electrode;
(b) flowing a first volume of water through the water system such that the first volume of water flows through the ion dispenser such that the first electrode and the second electrode are each positioned in contact with the first volume of water;
(c) selecting an electric current to apply to the first volume of water;
(d) determining a first electric potential energy differential to apply to the first volume of water, wherein the first electric potential energy differential is operable to generate the electric current;
(e) generating a first electrical charge on the first electrode and a second electrical charge on the second electrode, wherein the first electrical charge is greater than the second electrical charge, wherein the first and second electrical charges define the first electric potential energy differential therebetween; and
(f) applying the electric current to the first volume of water.

2. The method of claim 1, further comprising:
upon providing the electrical current to the first volume of water, dosing the first volume of water with a plurality of metal ions.

3. The method of claim 2, wherein the plurality of metal ions includes copper ions.

4. The method of claim 2, wherein the plurality of metal ions includes iron ions.

5. The method of claim 2, wherein the plurality of metal ions includes copper ions and iron ions.

6. The method of claim 1, wherein determining a first electric potential energy differential includes calculating an electrical conductivity of the first volume of water flowing between the first and second electrodes.

7. The method of claim 6, wherein the ion dispenser is in communication with a controller, wherein determining the first electric potential energy differential is repeated at regular intervals by the controller, the method further comprising:
adjusting the first electric potential energy differential between the first and second electrodes based upon the calculation of the electrical conductivity of the first volume of water flowing between the first and second electrodes to generate the electric current.

8. The method of claim 6, wherein the ion dispenser is in communication with a controller, wherein determining the first electric potential energy differential is repeated at regular intervals by the controller, the method further comprising:
adjusting the first electric potential energy differential between the first and second electrodes based upon an increase in electrical resistance between the first and second electrodes to generate the electric current.

9. The method of claim 6, wherein the ion dispenser is in communication with a controller, wherein determining the first electric potential energy differential is repeated at regular intervals by the controller, the method further comprising:
adjusting the first electric potential energy differential between the first and second electrodes based upon an increase in a separation distance between the first and second electrodes to generate the electric current.

10. The method of claim 6, further comprising:
based upon the calculation of the electrical conductivity of the first volume of water flowing between the first and second electrodes, purging at least a portion of the first volume of water from the water system if the electrical conductivity exceeds a predetermined electrical conductivity threshold.

11. The method of claim 10, wherein the water system includes a purge valve for purging at least a portion of the first volume of water from the water, the method further comprising:
initiating an OPEN-CLOSE or a CLOSE-OPEN sequence on the purge valve, wherein the OPEN-CLOSE or the CLOSE-OPEN sequence is operable to clean a residue off of the purge valve.

12. The method of claim 6, wherein calculating the electrical conductivity includes applying the formula:
R=ρ*L/S
wherein ρ represents a conductivity of the first volume of water between the first and second electrodes, L represents a separation distance between the first and second electrodes, and S represents an exposed surface area of each of the first and second electrodes to the first volume of water.

13. The method of claim 1, further comprising:
measuring an accumulation of electrical current on a selected one of the first or the second electrode over a predetermined time period; and
calculating a mass of the selected one of the first or the second electrode using the measurement of electrical current.

14. The method of claim 1, further comprising:
measuring an accumulation of electrical current on a selected one of the first or the second electrode over a predetermined time period; and
calculating a thickness of the selected one of the first or the second electrode using the measurement of electrical current.

15. A water treatment system, comprising:
(a) an ion dispenser, wherein the ion dispenser comprises:
(i) a housing defining a central passageway arranged between a first open end and a second open end, wherein the central passageway is configured to permit a fluid to pass therethrough from the first open end to the second open end;
(ii) a first electrode positioned within the central passageway in contact with the fluid, wherein the first electrode is configured to receive a first electrical charge;
(iii) a second electrode positioned within the central passageway in contact with the fluid, wherein the second electrode is configured to receive a second electrical charge; and
(iv) a controller in communication with the first and second electrodes, wherein the controller is programmed to:
(1) determine a first electric potential energy differential to apply to between the first and second electrodes, wherein the first electric potential energy differential is operable to generate a predetermined electric current, and
(2) generate the first electrical charge on the first electrode and the second electrical charge on the second electrode, wherein the first electrical charge is greater than the second electrical charge, wherein the first and second electrical charges define the first electric potential energy differential therebetween;
wherein the first electrode is configured to release one or more metal ions into the fluid as the fluid passes between the first open end and the second open end.

16. The water treatment system of claim 15, wherein the first electrode has a mass of about 1 kg to about 1000 kg.

17. The water treatment system of claim 15, wherein the first open end of the housing comprises a diameter between about 20 and about 60 inches.

18. The water treatment system of claim 15, wherein the housing comprises a housing material configured for use at a temperature of at least about 90 degrees Celsius.

19. The water treatment system of claim 15, further comprising,
at least one electrical connector coupling the first and second electrodes with the controller, wherein the at least one electrical connector comprises a connector material configured for use at a temperature of at least about 90 degrees Celsius.

20. The water treatment system of claim 15, wherein the housing includes an outer layer and an inner layer, wherein the inner layer includes an electrical insulating material.

21. A method of treating water, comprising:
(a) providing an ion dispenser system having a controller, wherein the ion dispenser system is in communication with the controller;
(b) flowing a liquid volume through the ion dispenser system, wherein the ion dispenser system includes a first electrode and a second electrode, wherein the first electrode and the second electrode are each positioned in contact with the liquid volume;
(c) measuring a first electrical conductivity of the liquid volume flowing between the first and second electrodes;
(d) comparing the measured first electrical conductivity of the liquid volume with a predetermined electrical conductivity range; and
(e) upon determining that the measured first electrical conductivity of the liquid volume is greater than the predetermined electrical conductivity range, initiating a purge of a portion of liquid from the liquid volume.

22. The method of claim 21, further comprising:
upon initiating the purge of the liquid from the liquid volume, measuring a second electrical conductivity of the liquid volume flowing between the first and second electrodes;
comparing the measured second electrical conductivity of the liquid volume with the predetermined electrical conductivity range; and
terminating the purge of the liquid from the liquid volume once the measured second electrical conductivity of the liquid volume is within the predetermined electrical conductivity range.
